(19) United States
(12) Patent Application Publication
(10) Pub. No.: US 2021/0065568 A1
(43) Pub. Date: Mar. 4, 2021

(54) LANGUAGE ACQUISITION SYSTEM

(71) Applicant: Joosung O, Seoul (KR)

(72) Inventor: Joosung O, Seoul (KR)

(21) Appl. No.: 16/961,241

(22) PCT Filed: Dec. 12, 2018
(86) PCT No.: PCT/KR2018/015772

§ 371 Date: Jul. 9, 2020

(30) Foreign Application Priority Data
Jan. 12, 2018 (KR) 10-2018-0004592

(51) Int. Cl. G09B 5/06; G06F 16/955; G09B 19/06; G09B 19/02; G09B 15/00

(52) U.S. Cl. CPC G09B 5/06; G06F 16/955; G09B 15/00; G09B 19/025; G09B 19/06

(57) ABSTRACT

The present invention relates to a language acquisition system and, more particularly, to a language acquisition system capable of allowing for unconsciously language acquisition by using an unconscious language cognitive model and a distributed iterative model for long-term memory.

### TECHNICAL FIELD

The present invention relates to a language acquisition system and, more particularly, to a language acquisition system capable of allowing for unconsciously language acquisition by using an unconscious language cognitive model and a distributed iterative model for long-term memory.

### BACKGROUND ART

Due to the development of transportation and the Internet technology, exchanges between countries are actively progressing and a global network is being established. In addition, interest in and importance of foreign language education are increasing significantly along with language education in the native language of the country.

In the case of Korea, although various teaching materials and learning methods for foreign languages such as English, Chinese and Japanese, are being disclosed and the learner try various methods for learning foreign languages, it is true that the rate of failure is higher than the rate of success.

In fact, the root cause of failing foreign language education is obvious. When foreign language learners first learn a foreign language, they overlook the specificity of the language and don't follow the universal acquisition method of the language in which they have learned and acquired their native language. And they think of the acquisition of a foreign language as a study that only understands with their head, and equate it with study.

Since all languages, including the native language, have commonalities in the acquisition process, it is necessary to derive a language acquisition method that fits the characteristics of the language by analyzing the natural acquisition process in which the baby acquires the native language in order to succeed in acquiring the foreign language.

### DISCLOSURE

### Technical Problem

The present invention has been devised to solve the above problems, and an object of the present invention is to solve fundamental problems for the entire language including the above-mentioned foreign language education problems. In addition, it is to provide a language acquisition system capable of unconscious language acquisition by using an unconscious language cognitive model and a distributed iterative model for long-term memory.

In addition, the present invention is characterized in that the four areas of the language (listening, speaking, reading, writing) are divided into two areas of “listening, speaking” and “reading and writing”. And the object of the present invention is to provide a language acquisition system optimized for the characteristics of each divided area by dividing the above two areas into an absorption (the result of the content being presented unconsciously and repeatedly) method acquired through unconscious repetition and a study method acquired through conscious learning and reading.

The language can be divided into a language of narrow sense (vocal language, text language-native language, foreign language) and a language of broad sense (voice language, text language, gesture language, code language, pictorial language, mathematical language, music language, etc). In addition, the language of narrow and broad sense can be applied to the listening and speaking acquisition program (the absorption program) and the reading and writing acquisition program (the study program) respectively, according to the characteristics of each language. Through this, the present invention aims to solve the fundamental problems of the entire language including the foreign language education problem by providing an optimized universal language acquisition system.

### Technical Solution

In order to achieve the above object, the language acquisition system according to the present invention is characterized by including a foreign language acquisition management unit and a program execution unit. The foreign language acquisition management unit provides an absorption acquisition program (non-study acquisition program), which is an acquisition program for listening/speaking, and a study acquisition program, which is a learning program for reading/writing. The program execution unit includes a set content DB corresponding to a level divided for each user's level, and executes an absorption acquisition program and a study acquisition program provided by the foreign language learning management unit according to the user's learning level, and provides it to the user.

The foreign language acquisition management unit is characterized by including an absorption acquisition program module and a study acquisition program module. Here, an absorption I acquisition program module controls repetitive feedback of absorption content provided according to an unconscious and passive acquisition method for listening and speaking. The study acquisition program module controls repetitive feedback of study content provided according to a leading and active acquisition method for reading and writing.

The repetitive feedback is characterized in that the content belonging to the set content are sequentially provided to the user, and once output of all content is completed, the first round is ended and next round is provided cumulatively and repeatedly. In other words, it is a learning method that recognizes and stores it as long-term memory by providing the content cumulatively and repeatedly. The set content is set by bundling the content provided at one time. The content includes the basic content composed of basic syllables, words, idioms, sentences, paragraphs (text composed of at least two sentences), picture language (=picture image language), gesture language, code language, mathematical language, and music language.

In addition, acquisition image, audio acquisition data, and convergence acquisition data related to the basic content may be provided. Individual content for each unit can be provided through various platforms such as apps, web, artificial intelligence (AI), robots, books, etc., by selecting at least one of text, voice (sound), image (picture), and video media.

The absorption acquisition program module basically provides set content through repetitive feedback, but provides an interface for selecting (inputting) “removal” in response to a user among content in the set content, if “removal” is selected from the user for a specific content, after the corresponding round is finished, provides repetitive feedback in such a way that the remaining set content except the content that “removal” was selected is provided in the next round, and provides the repetitive feedback until “Removal” is selected for all content contained in set content.

If the corresponding round for the set content is finished after the “removal” is selected, the absorption acquisition program module performs a test on the content in which the “removal” is selected and then proceeds the next round. Or, the absorption acquisition program module proceeds the next round without additional test until “removal” is selected and stored about all content included in the set content as a result of repetitive feedback. And, in the case of the test acquisition mode, if the test for all content is finished, it stops repetitive feedback on the current set content and proceeds repetitive feedback on the next set content.

The absorption acquisition program module may provide an interface that the user can select “removal” after providing the user with repetitive feedback for the set content for a predetermined number of rounds to prevent the user from selecting “remove” randomly without fully understanding the content.

The study acquisition program module basically provides repetitive feedback for the set content in the same manner as the absorption acquisition program, but provides an interface for selecting “study” as the user's reaction among the content in the set content. Then, if the user selected “study” for a specific content after the corresponding round is finished, it provides repetitive feedback in such a way that the content that “study” was selected among the content in the set content is provided in the next round, and provides the repetitive feedback until “study” isn't selected for all content contained in the set content.

The study acquisition program module may provide an interface that the user can select “study” after providing the user with repetitive feedback for the set content for a predetermined number of rounds to prevent the user from not selecting “study” randomly without fully understanding the content.

### Advantageous Effects

As described above, the language acquisition system according to the present invention divides into “listening/speaking” and “reading/writing” among the four areas of language. It provides a learning system that is optimized for the characteristics of each area by dividing it into the absorption method that is naturally acquired through unconscious repetition and the study method that learns consciously. Therefore, there is an excellent effect of efficiently acquiring a foreign language within a normal period, such as a native speaker, so that it can be used in everyday life.

### DESCRIPTION OF DRAWINGS

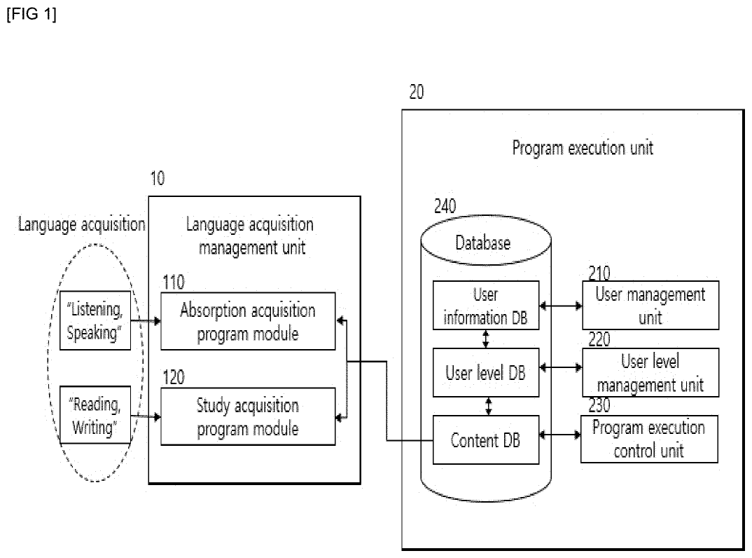

The FIG. 1 is a system configuration diagram schematically showing a language acquisition system according to a preferred embodiment of the present invention.

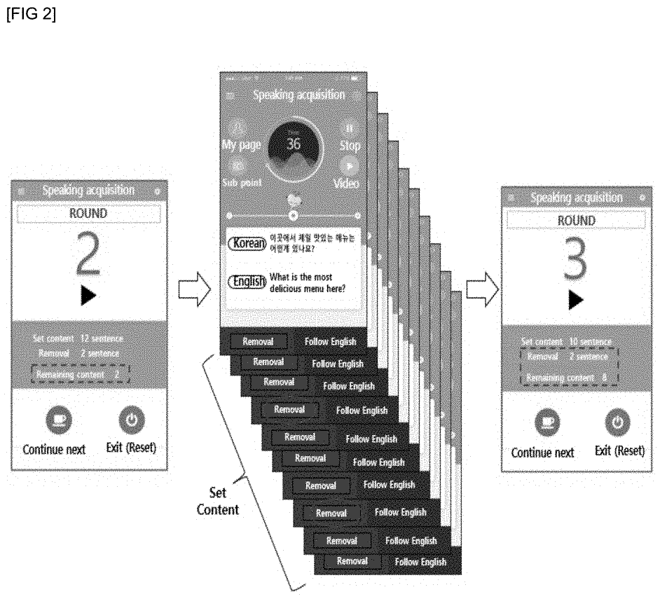

The FIG. 2 schematically shows repetitive feedback according to an absorption mode according to a preferred embodiment of the present invention.

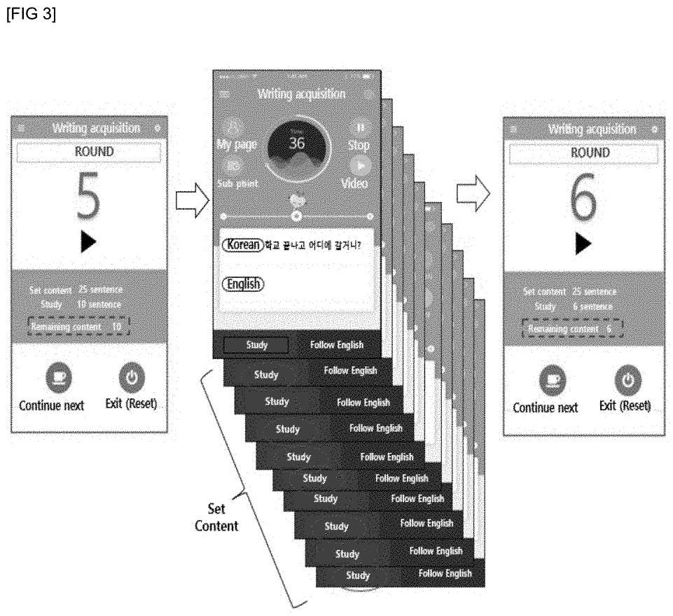

The FIG. 3 schematically shows repetitive feedback according to a study mode according to a preferred embodiment of the present invention.

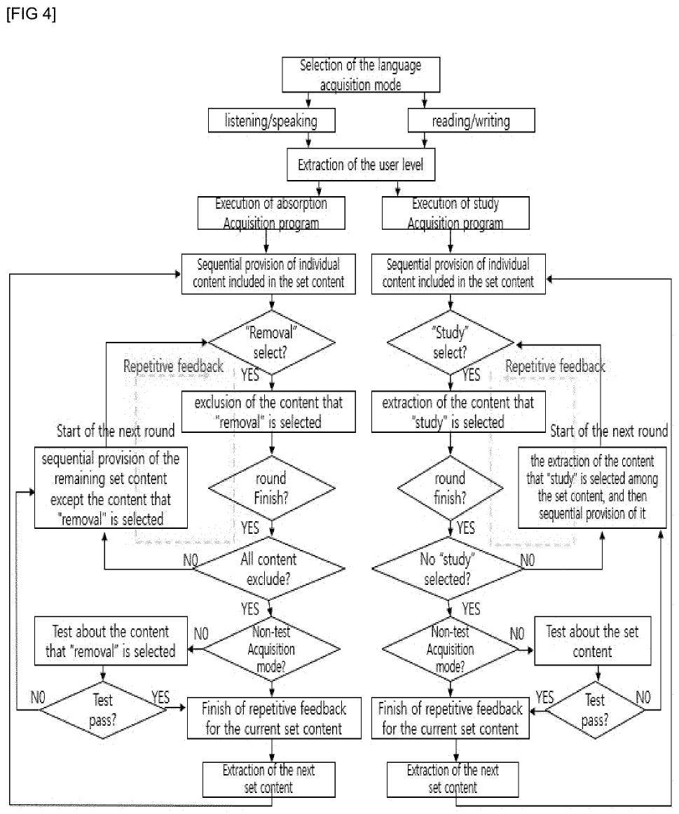

The FIG. 4 is a flowchart schematically illustrating a language acquisition method according to a preferred embodiment of the present invention.

### BEST MODE

The best form for the implementation of the language acquisition system according to the present invention is characterized by including a foreign language acquisition management unit and a program execution unit. The foreign language acquisition management unit provides an absorption acquisition program (non-study acquisition program), which is an acquisition program for listening/speaking, and a study acquisition program, which is a learning program for reading/writing. The program execution unit includes a set content DB corresponding to a level divided for each user's level, and executes an absorption acquisition program and a study acquisition program provided by the foreign language learning management unit according to the user's learning level, and provides it to the user.

### Modes of the Invention

Hereinafter, a specific embodiment of the present invention is described in detail with reference to the drawings.

The present invention can be applied to the acquisition of all foreign languages other than the user's native language. More specifically, the characteristics of listening, speaking, reading, and writing, which is four areas of language, are divided into the absorption mode that is acquired through unconscious repetition and the study mode that consciously learns and reads to achieve optimal learning for each area.

More specifically, “listening and speaking” among the four areas of language has a characteristic acquired through an incessant and unconscious and passive absorption process in which a baby undergoes childhood from an infant and is naturally received by a parent.

On the other hand, “reading and writing” is a subsequent process of listening and speaking, and a young child who has learned listening and speaking acquired for many years gradually becomes subjectively conscious through the education and training process. Therefore, “reading and writing” has a characteristic acquired through an active learning and understanding process.

In other words, “listening” and “speaking” are acquired unconsciously by absorbing for many years as they grow from babies to children, but “reading” and “writing” go through the process of active learning through subjective awareness and learning through the curriculum. When a certain level is exceeded, the four areas of language, ‘listening’, ‘speaking’, ‘reading’ and ‘writing’, together with other areas of science, are fused together and develop further through the process of convergence of natural acquisition and active learning.

If the language ability exceeds a certain level, the four areas of language, ‘listening, speaking, reading, and writing’ further develop through the fusion process of absorption that is all unconsciously acquired and active learning (study).

Therefore, among the four areas of language, “listening, speaking” and “reading and writing” have different learning characteristics, so it is necessary to classify and apply an optimized acquisition system according to the characteristics that is acquired.

Accordingly, in the present invention, the acquisition system of “listening, speaking” was constructed by an absorption method reflecting the characteristics of being unconsciously and passively acquired. On the other hand, the acquisition system of “reading and writing” was constructed by a study method reflecting the characteristics of being actively acquired through the process of learning and understanding.

The FIG. 1 is a system configuration diagram schematically showing a language acquisition system according to a preferred embodiment of the present invention.

Referring to FIG. 1, The present invention can be configured to include a language acquisition management unit (10) and a program execution unit (20). The language acquisition management unit (10) provides an absorption acquisition program (non-study acquisition program) which is an acquisition program for listening/speaking and a study acquisition program which is a learning program for reading/writing. The program execution unit (20) includes a set content DB corresponding to a level divided for each user's level, and executes an absorption acquisition program and a study acquisition program provided by the foreign language acquisition management unit according to the user's acquisition level, and provides it to the user.

The language acquisition management unit comprises an absorption acquisition program module (110, non-study acquisition program being acquired by unconsciously infusion) controlling repetitive feedback of absorption content being provided according to an unconscious and passive acquisition method for listening and speaking; and a study acquisition program module (120) controlling repetitive feedback of study content being provided according to a leading and active acquisition method for reading and writing.

The present invention basically adopts the principle of acquisition through repetitive feedback. Through this, the content is unconsciously injected to the user or the user actively learns the content.

The set content is set by grouping the content (for example, 10 sentences) provided at one time, and the repetitive feedback is a learning method for recognizing and storing the set content as a long-term memory by repeatedly providing the set content for each round to the user.

Here, the content means basic content composed of syllable, word, idiom, sentence, and paragraph constituting a language, as well as acquired image, voice acquisition materials, and convergence acquisition materials related to the basic content.

In the case of a character language, which is a language of narrow sense, ‘syllable, word, idiom, sentence, and paragraph (=text composed of at least two sentences)’ may be selected and provided as basic content. In the case of a gesture language among a broad language, at least one ‘action’ may be selected and provided as a basic unit of content. In the case of a picture language, at least one picture (image) can be selected and provided as basic content. In the case of a mathematical language, at least one ‘number or formula’ may be selected and provided as the basic content. In the case of a music language, at least one ‘score’ may be provided as a basic unit of content.

In addition, image (picture) acquisition data, voice (sound) acquisition data, and the fusion acquisition data related to the content, converged acquisition materials in which the content is fused can be expanded and provided as the basic unit.

For example, in the case of syllable, one syllable becomes individual content, in the case of word, one word becomes individual content, in the case of sentence, one sentence becomes individual content, and in the case of paragraph, one paragraph becomes individual content. Here, the paragraph means a unit composed of at least two sentences. In addition, when it is composed of pictorial language (=pictorial image language) units, one picture image becomes individual content, and when it consists of at least two picture (image) units, at least two picture images become individual content. The same can be applied to other broad languages such as gesture language, sign language, mathematical language, and music language.

And in the case of listening and speaking, voice data can be the main content, and in the case of reading and writing, text data can be the main content, but both of them can generally be composed in the form of content in which text, voice, image, and video are fused.

When the output of all the content is completed by sequentially providing the contents belonging to the set contents, the first round is ended. In other words, the repetitive feedback is a learning method that provides by round unit cumulatively and repeatedly. Therefore, if the set content is repeatedly provided 10 times, it means that the acquisition process of 10 rounds (round 1˜round 10) acquisition process has been performed.

Here, in order to increase an acquisition effect during the repetitive feedback, a sequence in which content belonging to set content are output may be provided differently for each round.

If the set content is provided in the same order in a repetitive round, instead of focusing on the content itself, the entire set content can be accepted as one and accepted as memorization rather than natural and unconscious infusion acquisition. Therefore, it is desirable to provide a different order for each round so as to focus on each content.

According to Dr. Noam Chomsky's unconscious language cognitive model, language is acquired through a following sequence of steps; a sensory receptive step through auditory and visual input, a selective perceptual step through conscious attention, a short-term memory step that converts into short-term memory, a long-term memory step that converts into long-term memory, and a retrieval step that searches from the long-term memory.

The repetitive feedback method is a learning method designed for the unconscious language cognitive model as described above.

The repetitive feedback basically provides the set content to the user infinitely or finitely and stores it as long-term memory through unconscious acceptance and perception. Here, the method of providing specific repetitive feedback varies depending on whether the acquisition method is absorption mode or study mode. That is, absorption mode and study mode are classified according to whether the user's action is involved in repetitive feedback and how the user's action is involved.

The FIG. 2 schematically shows repetitive feedback according to an absorption mode according to a preferred embodiment of the present invention.

First, the absorption acquisition program module 110 basically provides through repetitive feedback on the set content, but provides an interface for selecting (inputting) “removal” in response to a user among content in the set content. Then, if “removal” is selected for a specific content, after the corresponding round is finished, it provides repetitive feedback in such a way that the remaining set content except the content that “removal” is selected is provided in the next round. And it provides repetitive feedback until “Removal” is selected for all content contained in set content.

Since the absorption acquisition program is built on the model of the baby's constant trial and error, the removal button is provided for the intention to remove it when it is determined that the learner himself has been fully acquired. This is the same logic as the baby constantly listens to the mother's voice countless times and continuously trains “listening-speaking”. Because baby has the right to freedom, he can burst into tears to express his intention not to listen or respond anymore. This act of trying to stop the mother's act is the same principle as the act of the learner selecting the removal button.

That is, while the content included in the set content is sequentially provided, the user may select “removal” for the content determined to have been fully acquired. This is an expression that the user is completely aware of the passively injected content and does not want to listen anymore.

The absorption acquisition program module 110 provides a content included in a set content sequentially to the user, and when all contents included in the one set contents are provided, provides a repeat feedback to repeatedly provide the set content in a round unit.

In addition, if there is a “removal” input for a specific content from a user, it stores “removal” information for the corresponding content.

Here, it may provide interface that the user can select “removal” after providing the user with repetitive feedback for the set content for a predetermined number of rounds to prevent the user from selecting “remove” randomly without fully understanding the content.

When the corresponding round for the set content is ended after the “removal” is input, the test for the content in which the “removal” is input may be performed, and then the next round may be acquired or the next round may be performed without a separate test.

When the removal input is selected for the content, a method of testing the removed content before providing the next round of set content is defined as a test acquisition mode. In addition, a method of providing a next round for set content excluding the removal input contents without a separate test is defined as a non-test acquisition mode.

If the user's “removal” selection is the baby's response, then the test acquisition mode or the non-test acquisition mode is the mother's response to the baby's reaction.

That is, the mother may acknowledge the baby's reaction and may no longer speak, and, conversely, the mother may acknowledge only a portion of the baby's reaction, and may decide whether or not the mother will continue to speak while looking at the baby. This corresponds to the test acquisition mode.

The non-test acquisition mode does not provide a test for the content even if the user selects the removal for the specific content, such as the mother acknowledges the baby's reaction and does not speak anymore. Then in the next round, the remaining set content excluding content that removal is selected is repeatedly provided.

In addition, the test acquisition mode does not immediately remove the corresponding content even if the user selects the removal, and the test is performed after the ongoing round ends, as the mother decides later while retaining an immediate judgment on the baby's rejecting behavior. In addition, only the content that the user has passed a predetermined criterion at test is excluded from the set content and the rest of the set content is provided in the next round. Therefore, the present invention can provide repetitive feedback while checking whether the user has fully acquired the content through the test acquisition mode.

Repetitive feedback through the above process is provided. Here, when “removal” is selected and stored for all content of the set content, and the test for all contents is finished, repetitive feedback for the current set content is stopped and the next set content are provided.

The FIG. 3 schematically shows repetitive feedback according to a study mode according to a preferred embodiment of the present invention.

On the other hand, the study acquisition program module 120 basically provides repetitive feedback for the set content in the same manner as the absorption acquisition program, but provides an interface for selecting “study” as the user's reaction among the content in the set content, Then, if “study” is selected for a specific content, after the corresponding round is finished, it provides repetitive feedback in such a way that the content that “study” was selected among the content in the set content is provided in the next round, and provides the repetitive feedback until “study” isn't selected for all content contained in the set content.

‘Reading and writing’ is a process that requires a systematic explanation for understanding or thinking. Therefore, it is different from the process acquired by simple injection such as ‘speaking and listening’. Study is essential for the learner's active choice and concentration (thinking). Therefore, in the study process, the content to be learned by the learner (the user) must be selected without error, and the selected content should be provided in the next round. Therefore, a learner's nerve concentration is required.

That is, it is important for the learner's judgment to decide whether to re-learn (=review) the content that is lacking in understanding in the next round, so the learner actively decides whether or not to select ‘study’

Here, the ‘study’ is the user's response to the content that is considered to be more necessary to learn among the contents provided as the set content, and the study acquisition program module provides an interface through which the user can select ‘study’.

More specifically, the study acquisition program module 120 sequentially provides set content to a user. In addition, when all set content is provided, it provides set content with repetitive feedback provided repeatedly in a round unit.

And when there is a “study” input for a specific content from the user, it stores “study” information for the content.

As like the absorption acquisition program, the study acquisition program module also may provide an interface that the user can select “study” after providing the user with repetitive feedback for the set content for a predetermined number of rounds to prevent the user from not selecting “study” randomly without fully understanding the content.

After the first round of the set content is provided through the above process, only the content selected as “study” among the set content is extracted, and the next round is proceeded only with the extracted content.

If “study” is not selected from the user for all content included in the set content in a specific round provided through the repetitive feedback process, the study acquisition module determines that learning of the set content is completed and no further learning is required. Therefore, it finishes repetitive feedback. And if the score of the test is greater than or equal to the standard score after the test for the current set content, the next set content is provided.

If the test result is less than the standard score, repetitive feedback is again performed on the set content extracted only from the wrong content in the test.

As described above, the language acquisition system according to the present invention induces the user to acquire ‘speaking and listening’ among the four areas of language by the absorption (cramming user's head with knowledge) method and induces to acquire ‘reading and writing’ by the study method.

In the case of ‘speaking, listening’, the present invention provides an interface for the user to select “removal” for content that is definitely acquired. It is a structure in which repetitive feedback can be provided infinitely without user action (selecting “removal”). On the other hand, in the case of ‘reading and writing’, it provides an interface for the user to select “study” for content that requires additional learning. Therefore, if there is no user action, the repetitive feedback is terminated, and thus has a finite structure.

The program execution unit 20 manages a user participating in learning, and is responsible for providing content to be used for an acquisition program provided through the language acquisition management unit.

More specifically, the program execution unit 20 may include a user management module 210, a user level management module 220, a program execution control module 230 and a database 240.

The user management module 210 performs user registration and authentication.

The user level management module 220 manages the level according to the foreign language level of the authenticated user.

The program execution control module 230 controls program execution by extracting customized set content according to a user's level.

The database 240 stores and manages user information, level information of the user, absorption content for acquiring ‘speaking and listening’ classified by level and study content for acquiring ‘reading and writing’.

Hereinafter, a foreign language acquisition method according to a preferred embodiment of the present invention is described.

The FIG. 4 is a flowchart schematically illustrating a language acquisition method according to a preferred embodiment of the present invention.

First, a user participating in foreign acquisition learning accesses the program execution unit through the user's terminal and performs the preparation process for learning through user authentication.

The terminal may be composed of any terminal that can access the Internet, such as a PC, laptop, tablet PC, netbook, mobile phone, Ai speaker. The terminal should be provided with an acquisition application that provides a foreign language acquisition program according to the present invention. The acquisition application can be installed and downloaded by accessing the program execution unit.

Here, if the user is accessed for the first time, the user management module 210 receives user information, performs user registration, and determines the user's language level through test.

The user information may include ID, password which are unique identification information of the user and personal information.

In the case of a user who is already registered, the user is verified through login authentication, and the user level management module 220 specifies the set content based on the level information of the user that has already been stored and the previous learning history.

Subsequently, the user selects a desired acquisition mode.

If the user selects ‘Listening, Speaking’ acquisition, the absorption program is executed, and if the user selects ‘Reading, Writing’ acquisition, the study program is executed.

First, when the ‘listening and speaking’ acquisition is selected and the absorption program is executed, set content specified according to a user's level and previous learning history is provided.

The set content is composed of N numbers of content, and the N numbers of content are sequentially provided at predetermined time interval. Here, the time interval between the content may proceed according to a preset time. In addition, the user can arbitrarily adjust the time interval by shortening or extending the time.

The user proceeds to acquire through the individual content included in the set content, and selects (inputs) “removal” for the content that is fully understood.

When the progress of all the individual content included in the set contents is completed, the current round is ended, and the content with the “removal” is excluded from the set content.

Then, acquisition of the next round is performed for the remaining content except the content for which “removal” is selected from the set content.

If “Removal” is selected for all the individual contents included in the set content in the test mode and there is no content to acquire in the next round, the user performs a test on the current set content. If the user's score is greater than or equal to the set reference score, acquisition about the next set content proceeds, and if the user's score is less than the set reference score, incorrect content in the test is extracted, and repetitive feedback on the extracted content is provided.

In the non-test mode, the acquisition about the current set content is completed and the acquisition about the next set content is provided.

Next, when ‘reading and writing’ learning is selected and the study program is executed, set content specified according to a user's level and previous learning history is provided.

The set content is composed of N numbers of content as like “listening, speaking’ acquisition, and the N numbers of content are sequentially provided at predetermined time interval. Here, the time interval between the content may proceed according to a preset time. In addition, the user can arbitrarily adjust the time interval by shortening or extending the time.

The user proceeds to learn through the individual content included in the set content, and selects “study” for content that requires additional learning because it is not fully understood.

When the progress of all the individual content included in the set content is completed, only the content that the “study” is selected is extracted from the set content.

Then, only content selected with “study” among the set content is extracted, and learning of the next round is provided.

If “Study” is not selected for all the individual contents included in the set content in the test mode and there is no content to acquire in the next round, the user performs a test on the current set content. If the user's score is greater than or equal to the set reference score, learning about the next set content proceeds, and if the user's score is less than the set reference score, incorrect content in the test is extracted, and repetitive feedback on the extracted content is provided.

In the non-test mode, the learning about the current set content is completed and the learning about the next set content is provided.

According to the above absorption acquisition program and study acquisition program, the present invention can effectively acquire language through finite or infinite repetitive feedback learning.

In the detailed description of the present invention described above, the preferred embodiments of the present invention have been described, but the protection scope of the present invention is not limited to the above embodiments. Therefore, it will be applicable to various functional fields and academic worlds that require absorption and study (learning) methods.

Those of ordinary skill in the art will appreciate that various modifications and changes can be made to the present invention without departing from the spirit and technical scope of the present invention.

### INDUSTRIAL APPLICABILITY

The present invention relates to a language acquisition system and, more particularly, to a language acquisition system capable of allowing for unconscious language acquisition by using an unconscious language cognitive model and a distributed iterative model for long-term memory and is an invention with high industrial applicability.

1. A language acquisition system, comprising:
a language acquisition management unit providing an absorption acquisition program, which is an acquisition program for “listening/speaking”, and a study acquisition program, which is a learning program for “reading/writing”; and
a program execution unit including a set content DB corresponding to a level divided for each user's level, and executing the absorption acquisition program and the study acquisition program provided by the language acquisition management unit according to the user's acquisition level, and providing them to the user.

2. The language acquisition system according to claim 1, wherein
the language acquisition management unit comprises
a absorption acquisition program module controlling repetitive feedback of absorption content provided according to an unconscious and passive acquisition method for listening and speaking; and
a study acquisition program module controlling repetitive feedback of study content being provided according to a leading and active acquisition method for reading and writing.

3. The language acquisition system according to claim 2, wherein:
the repetitive feedback is an absorption and study method in which the content belonging to the set content (set by bundling the content provided at one time) is sequentially provided to the user, and once the output of all content is completed, the first round ends, and the next round is accumulated and repeatedly provided to recognize and store it as long-term memory;
In the case of vocal language and text language, which is the language of narrow sense, the content composed of syllables, words, idioms, sentences, and paragraphs (=text composed of at least two sentences) are selected and provided as the basic unit content;
and in the case of gesture language, which is the language of the broad sense, the content composed of at least one action are selected and provided as the basic unit content;
and in the case of a pictorial language, the content composed of at least one picture (image) are selected and provided as the basic unit content;
and in the case of a mathematical language, the content composed of at least one number or formula are selected and provided as the basic unit content;
and in the case of a music language, the content composed of at least one sheet music are selected and provided as the basic unit content;
the individual content of each unit is composed of at least one selected from text, voice (sound), image (picture), and video media, and is provide from one platform selected from apps, web, artificial intelligence (AI), robot, and book.

4. The language acquisition system according to claim 2, wherein:
the absorption acquisition program module basically provides the set content through repetitive feedback, but provides an interface for selecting (inputting) “removal” in response to a user among content in the set content; and
if the “removal” is input for a specific content, after the corresponding round is finished, provides repetitive feedback in such a way that the remaining set content except the content that “removal” is selected is provided in the next round and provides repetitive feedback repeating round until “Removal” is input for all content contained in set content.

5. The language acquisition system according to claim 4, wherein:
If the corresponding round for the set content is finished after the “removal” is selected, the absorption acquisition program module performs a test on the content in which the “removal” is selected and then proceeds the next round or;
proceeds the next round without additional test until “removal” is selected and stored about all content included in the set content as a result of repetitive feedback;
in the case of the test acquisition mode, if the test for all content is finished, stops repetitive feedback on the current set content and proceeds repetitive feedback on the next set content.

6. The language acquisition system according to claim 5, wherein:
the absorption acquisition program module may provide interface that the user can select “removal” after providing the user with repetitive feedback for the set content for a predetermined number of rounds to prevent the user from selecting “remove” randomly without fully understanding the content.

7. The language acquisition system according to claim 5, wherein:
the study acquisition program module basically provides repetitive feedback for the set content in the same manner as the absorption acquisition program, but provides an interface for selecting “study” as the user's reaction among the content in the set content,
Then, if “study” is selected for a specific content, after the corresponding round is finished, provides repetitive feedback in such a way that the content that “study” was selected among the content in the set content is provided in the next round, and provides the repetitive feedback , until “study” isn't selected for all content contained in the set content.

8. The language acquisition system according to claim 7, wherein:
The study acquisition program module may provide an interface that the user can select “study” after providing the user with repetitive feedback for the set content for a predetermined number of rounds to prevent the user from not selecting “study” randomly without fully understanding the content.
